(19) United States
(12) Patent Application Publication
(10) Pub. No.: US 2015/0200897 A1
(43) Pub. Date: Jul. 16, 2015

(54) METHOD AND SYSTEM FOR ROUTING AND ANALYZING MESSAGES

(71) Applicant: QUICKTEXT,INC, REDWOOD CITY, CA (US)

(72) Inventors: Resat Nuri Otus, Hillsborough, CA (US); Roger S. Sanford, San Jose, CA (US); David Thomas Harper, Orinda, CA (US); George Sibble, San Francisco, CA (US); Alexander Otus, Hillsborough, CA (US)

(21) Appl. No.: 14/597,199

(22) Filed: Jan. 14, 2015

Related U.S. Application Data
(63) Continuation-in-part of application No. 14/454,680, filed on Aug. 7, 2014.
(60) Provisional application No. 61/927,444, filed on Jan. 14, 2014.

(51) Int. Cl. H04L 12/58

(52) U.S. Cl. CPC H04L 51/22

(57) ABSTRACT

A computer-implemented method for routing and analyzing messages is disclosed. The method comprises monitoring messages associated with a messaging application running on a messaging device; detecting at least one message marked for routing and analysis; and sending each message marked for routing and analysis to an routing and analysis server or 3^{rd} party system directly for storage in association with a user account.

### PRIORITY

This application claims the benefit of priority to U.S. Provisional Patent Application No. 61/927,444 entitled METHOD AND SYSTEM FOR ARCHIVING TEXT MESSAGES and which was filed Jan. 14, 2014, and is a continuation-in-part of U.S. patent application Ser. No. 14/454,680 entitled SYSTEM AND METHOD FOR ARCHIVING MESSAGES and which was filed on Aug. 7, 2014, the entire specifications of which is incorporated herein by reference.

### FIELD

The present disclosure relates to messages and in particular to messages sent and received via mobile devices.

### BACKGROUND

The proliferation of mobile devices such as mobile phones and tablet computers in recent years has led to messaging becoming a popular way of communication both for personal and business communications. One messaging protocol is the Short Message Service (SMS) protocol. The volume of SMS messages sent on a daily basis is staggering.

Generally, the messages that are routinely sent and received are of an ephemeral nature and do not need routing, search and analysis. But, increasingly, business related messages, which are traditionally communicated via email, are now being sent via messaging applications. Additionally, the volume of these messages is becoming so large that it is difficult to track what is being said effectively.

Thus, there is a need to route, track, search and analyze messages such as SMS messages that is being fueled by the trend towards using messaging applications to send and receive business related messages.

### SUMMARY

According to a first aspect of the invention, a computer-implemented method for routing, searching and analyzing messages is disclosed. The method comprises monitoring messages associated with a messaging application running on a messaging device; detecting at least one message marked for routing; and sending each message marked for a particular set of metadata to a server for storage in association with a user account.

Other aspects of the invention will be apparent from the detailed description below.

### BRIEF DESCRIPTION OF THE DRAWINGS

FIG. 1 shows a deployment scenario in accordance with one embodiment of the invention in which a messaging device runs a client data collection application configured to send messages to a remote routing, search and analysis application running on a server.

FIG. 2 shows a sequence of operations performed by the client routing and analysis application, in accordance with one embodiment of the invention.

FIG. 3 shows a sequence of operations performed by the remote routing and analysis application, in accordance with one embodiment of the invention.

FIG. 4 shows a sample report generated by the remote routing and analysis application, in accordance with one embodiment of the invention.

FIG. 5 shows exemplary hardware for implementing the routing and analysis server, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block or flow diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to the details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

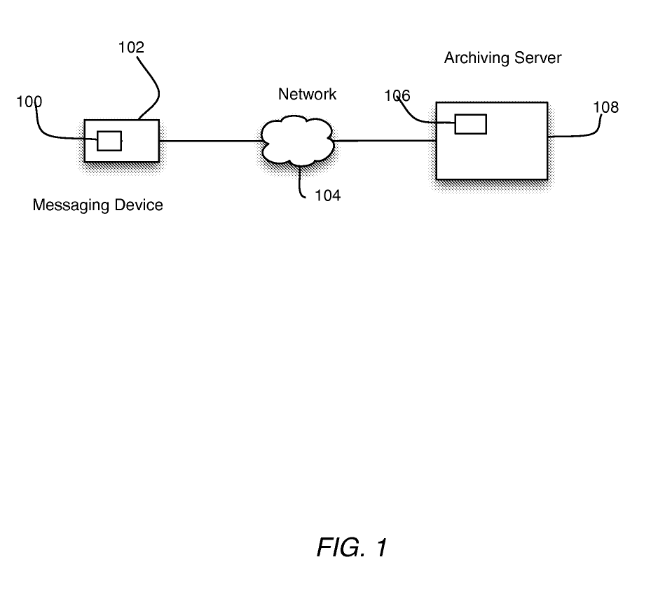

Referring to FIG. 1 of the drawings, a client data collection application 100 is provisioned to run on a messaging device 102 such as a mobile phone.

In one embodiment, the application 100 is configured to collect messages sent and received via the device 102 as will be described.

In one embodiment, messages to be routed, analyzed, tracked and searched are directly routed to a remote 3^{rd} party system 106. Said remote application may be running on an device, e.g. in the form of a server 108.

In one embodiment, messages to be routed, analyzed, tracked and searched are transmitted to a remote routing and analysis application 106. Said remote application may be running on an device, e.g. in the form of a server 108.

Transmission of the messages to be routed may be via an intermediate network 104. In accordance with difference embodiments, the network 104 may include a WiFi network, a wide area network (WAN) such as the Internet, etc.

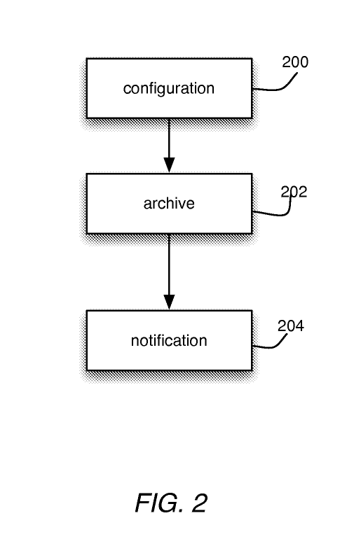

In one embodiment, the application 100 may support the processing blocks shown in FIG. 2. Referring to FIG. 2, at block 200 a configuration operation is performed. This operation captures various inputs from a user to enable an routing and analysis of messages, e.g. SMS, MMS messages, or messages from Over the top data (otp) services such as WhatsApp and wechat. For example, the configuration operation may capture user account information (user name and password) and routing and analysis preferences from a user. In one embodiment, the routing and analysis preferences may specify an routing and analysis schedule comprising routing and analysis events. During each routing and analysis event, the client routing and analysis application transmits the messages to be routed and analyzed to the remote application. Said schedule may include a frequency with for the routing and analysis events and a time of day at which to perform the routing and analysis events. In one embodiment, the routing and analysis schedule may be specified in terms of a predefined volumes of messages marked for routing and analysis that must be accumulated before an routing and analysis event occurs. For this embodiment, the messages marked for routing and analysis are sent in a message batch comprising all the messages marked for routing and analysis since the last routing and analysis event.

In one embodiment, the routing and analysis preferences may include specification of a special character(s) in a message subject that may denote to the application 100 that a message is to be included for archival for to be excluded. For example, a “#” in a message subject or in a message body at a designated location (e.g. at the beginning) may effectively mark a message for inclusion or exclusion in the next routing and analysis event.

In another embodiment the routing character may indicate the preference for the message or recent messages to be routed and analyzed into a particular system of choice or format of choice. For example #deal could indicate that the most recent messages involved a negotiation that should be routed to the appropriate sales or CRM system that hold sales data.

In another embodiment, the user may select particular conversations based on the recipients or participants in their list of conversations to be routed, analyzed or searched, and select to only conversations that they would prefer to be routed, analyzed and searched. This selection may be comprised of selection via their address book, or selection of phone numbers or email.

In another embodiment, the decision about which conversations should be backed up can be made based on the business relationship information from external data sources. This is accomplished by obtaining a list of the business contacts from a list that is made available locally, or by an internet service, such as a REST API, to the device. The list will contain first and last names, phone numbers, emails or address information. This information may contain information about the state of business dealings with the contact, such as a lead, account, sale or other similar customer relationship information. The list of information described above is matched against the information available on the phone such as the phone number and name, in order to decide which text messaging sessions have business relevance.

In another embodiment, the archival of a particular conversation can be determined to go to a particular backup location based on the conversation being annotated. The annotation would correspond to a business or consumer service location remote to the device. The annotation in one embodiment is automated via natural language processing to detect a schedule event, deal. In another embodiment the system may contextually scan the text of the messages in order to determine if a particular message warrants further attention. This scan will look for interesting words in the text which imply locations, dates, times, dollar amounts, names, technical terms, and product information. The application will assemble a list of such possible interesting events such that the employee can then choose an activity to perform. The activities may take a chunk of information and back up the data to a particular 3^{rd} party data storage location, CRM or other similar system.

In all embodiments, the data format of the messages may be comprised of at least a conversation container, which includes the parties involved (receivers, sender). In terms of message data, there may be text or binary data, including multimedia information such as pictures or videos. Messages also include date, time, send state information and possibly location information.

At block 202, the application 100 performs the routing, analysis operation. In accordance with different embodiments, steps under the routing operation may include encrypting messages since the last routing event and transmitting the encrypted messages to the routing and analysis application 106 via the network 104. In one embodiment, the routing operation may also transmit message sender/recipient information associated with each message, and the time of that each message was sent or received. In one embodiment, an entire message conversation may be transmitted for routing and analysis by the routing and analysis application 106.

The routing and analysis application will allow networked messages to go to the system from point a to point b reliably. As such it will consist of a message queueing system, a REST (representational state transfer), message networked relay (network element that helps with receipt, storage and transfer of data from one firewalled network to another), or other network (tcp/udp based) communications delivery service with a reliable delivery capability. The data transfer and storage mechanism needs to satisfy criteria of ACID (atomicity, consistency, isolation and durability).

The system for transferring messages to a will be able to take in multiple simultaneous inbound messages of different data types and store them locally, in a temporary location, which might be a in memory database, file system, or other data storage device, where they can be properly synchronized and await further processing. At the processing point, monitoring of user metadata regarding upload times, devices, phone number, location, and other phone related metadata will be captured and kept for later processing.

In another embodiment, the messages are routed directly into a 3^{rd} party without any intermediary system, and the routing and analysis step occurs directly on device.

In one embodiment, at block 204, the application 100 may provide periodic notifications in the form of a status report to a user to indicate a success or failure of the last performed routing and analysis operation.

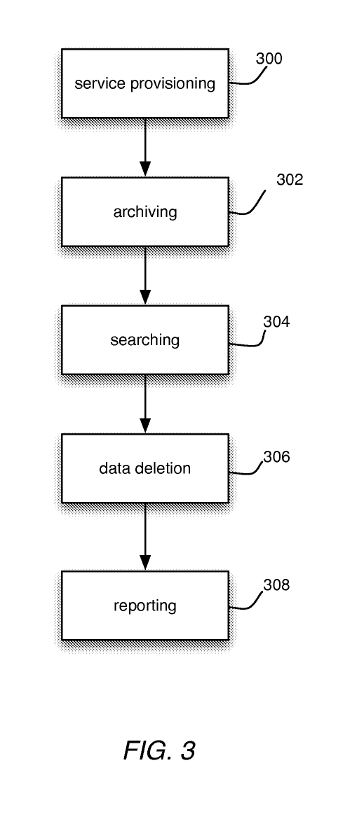

FIG. 3 shows the operations performed by the routing and analysis application 108 in accordance with one embodiment. Referring to FIG. 3, at block 300, a service-provisioning step is performed. Under this step a user account may be created to facilitate routing and analysis. Service provisioning information will include the internet location of the relay pipeline, direct data store locations for media, REST API service locations, encryption requirements around stored data, any encryption key or other similar information as required by data privacy law or legal agreement, the location of the routing and analysis servers over an ip network, and any credentials required to access the routing and analysis location and upload data to it. As such this is a multimodal routing and analysis solution that is designed to use a standardized transport container format such as xml, json or encrypted json to carry the data to various possible network destinations and systems.

At block 302, an analysis step is performed. This step includes receiving an request from the application 100, responsive to which the authentication of the user is performed. Once the user is authenticated, the messages that are received from the application 100 are prepared for routing and analysis. The latter step may include formatting the messages, e.g. into pdf format, json, or other format. Thereafter, the messages may be stored in memory an associated with the user's account.

Upon routing, the creation of the corresponding data structures in a local data store occurs, as is identical or largely similar to those on the server side of the messaging and routing and analysis services. This includes the conversation and message structures. Upon obtaining the data, a standard string or pattern matching algorithm is used to determine if the parties involved in the conversation to the local contact list are the same. The data used for matching will include the metadata of the contact, such as phone numbers, email, and address data for that person, such that a contact from one service may be matched based on the phone number, email or any other available information to the same contact in a messaging service. The attempt will be made also, by comparing the same information, to correlate any conversations from one message storage provider (such as SMS or iMessage) with another (such as WhatsApp or WeChat).

The messages themselves may be stored in any number of formats, including as a file based storage format, incremental storage container, database or other similar storage structure, such as a json document based NoSQL storage server, or relational store.

There is also the need to in the case where the text message is stored to a file system, secure the data such that the dates, times and recipients associated with the message cannot be altered after the data has been uploaded from the user device. The dates and recipients of the messages will be used along with a private key to generate a checksum or will be separately encrypted such that the decryption of that data will match the unencrypted stored data. The encrypted data will only be possible to decrypt using a key available to the service infrastructure and the device itself that holds the private encryption key.

In some embodiments, the stored messages may be indexed for search. At block 304, the application 108 performs a search operation to locate particular messages based on a search query initiated by the user. The search query can be performed local to the device or computer, and will allow the user to locate and identify messages to the same user as backed up from one or multiple message services. The messages will be searched based on the content or metadata of the messages, starting with the conversation containers, users involved, and their contact information such as phone numbers, emails and addressed.

In a further embodiment, the search may comprise the search of any multimedia data that may be attached. There may be additional steps applied to analyze this data, in particular converting audio to text for analysis. The goal of that search would be to extract any recorded audio information first and make such a transcript to be available in a text record. The search would be a text search of that transcript in addition to any content that is purely text.

In one embodiment, the application 108 may execute data deletion block 306. The block 306 may be configured to delete messages based on certain predefined message deletion criteria (e.g. messages that are older than a defined age) or based on a search query at the instance of the user to select messages for deletion. In one embodiment, the deletion criteria may be based on compliance requirements set by legislation.

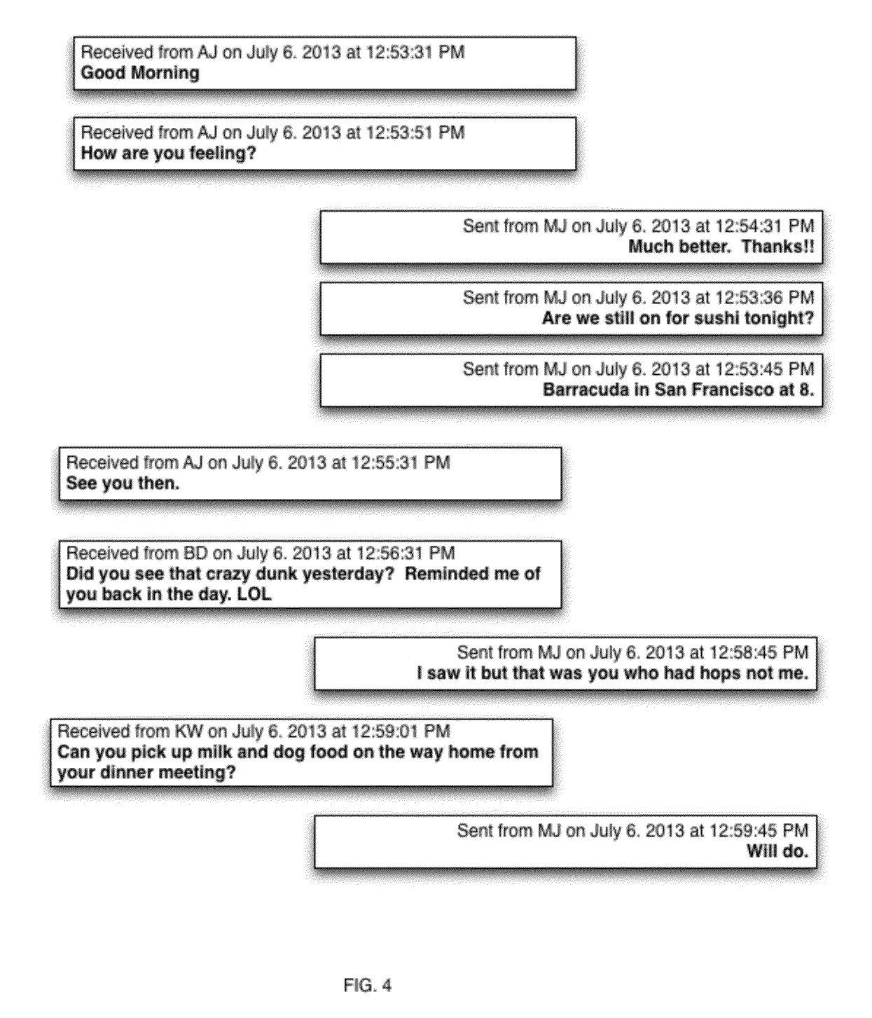

In one embodiment, the application may execute the block 308 to report on messages stored by the system. FIG. 4 shows a report generated in accordance with one embodiment. In one embodiment, a report of text messages sent and received may be sent via email to a user.

In one embodiment, the analysis engine will have an inference engine will analyze the data for connections between data, in order to recommend rules that could be used for real time analysis or non-real time. The inference engine can be given criteria for locating data that is important, including linkages between different types of data, such as audio, video, text or other structured data types, such as location, GPS or other metadata. The types of data searched for in an automated manner. Based on the inferences, notifications may be sent regarding potential routing choices. These notifications could happen over any number of communications methods, including SMS, audio, APNS (apple push notification service), GCMS (google cloud message service), xmpp (extensible messaging and presence protocol), sip (session initiation protocol), email or other similar communications protocols. Criteria for notification, i.e. rules, can be set regarding when data will trigger a notification. These criteria may be set in advance according to domain knowledge for the field of application. They may also be set based on a known list of keywords that are considered legal or other triggers. They may also be discovered based on inference from other messages that caused triggers to be fired. The type of notification, monitoring urgency, keywords, and other search criteria can be assigned based on the content discovered. This includes escalated communications monitoring or messages, includes automatic tagging of new inbound data, immediate alerts regarding when employees of interest send anything, real time content analysis, and immediate specialized routing and storage of data

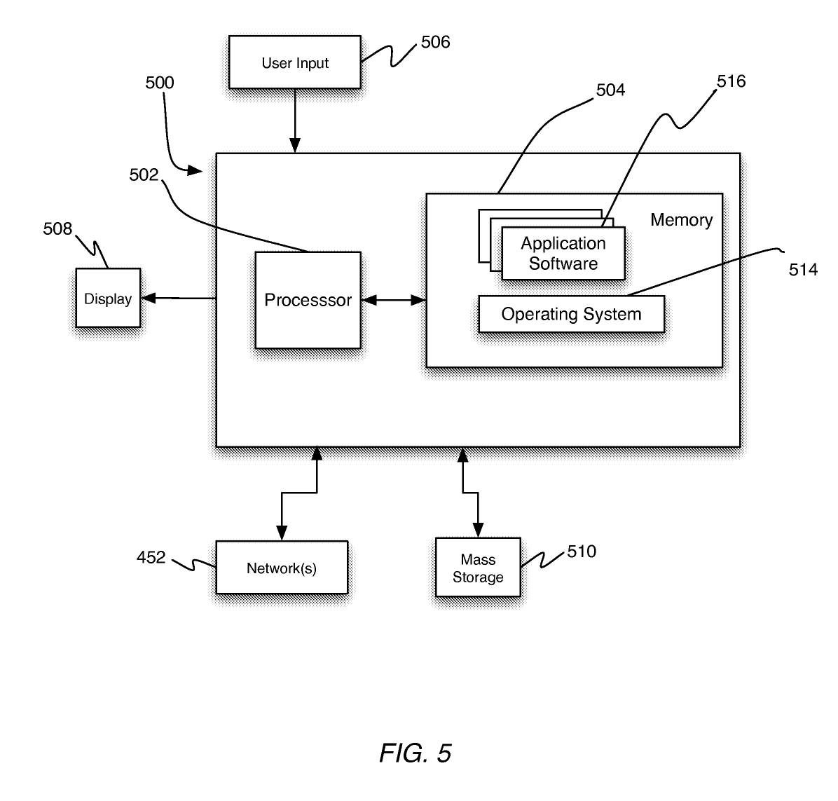

FIG. 5 shows a system 500, in accordance with one embodiment for implementing the analysis and routing server described herein. The system 500 may includes at least one processor 502 coupled to a memory 504. The processor 502 may represent one or more processors (e.g., microprocessors), and the memory 504 may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory 504 may be considered to include memory storage physically located elsewhere in the hardware, e.g. any cache memory in the processor 502, as well as any storage capacity used as a virtual memory, e.g., as stored on a mass storage device.

The system also typically receives a number of inputs and outputs for communicating information externally. For interface with a user or operator, the hardware may include one or more user input/output devices 506 (e.g., keyboard, mouse, etc.) and a display 508. For additional storage, the system 500 may also include one or more mass storage devices 510, e.g., a Universal Serial Bus (USB) or other removable disk drive, a hard disk drive, a Direct Access Storage Device (DASD), an optical drive (e.g. a Compact Disk (CD) drive, a Digital Versatile Disk (DVD) drive, etc.) and/or a USB drive, among others. Furthermore, the hardware may include an interface with one or more networks 512 (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor 502 and each of the components, as is well known in the art.

The system 500 operates under the control of an operating system 514, and executes application software 516 which includes various computer software applications, components, programs, objects, modules, etc. to perform the techniques described above.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include, but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

1. A computer-implemented method for routing, analyzing and searching messages, comprising:
monitoring messages associated with a messaging application running on a messaging device;
detecting at least one message marked for routing, analyzing or searching; and
sending each message marked for routing, analyzing, or searching to a server for further processing, or directly routing and analyzing the messages to a 3^{rd} party system in association with a user account.
